(19) United States
(12) Patent Application Publication
(10) Pub. No.: US 2015/0130115 A1
(43) Pub. Date: May 14, 2015

(54) METHOD FOR PREPARING ALUMINUM SUBSTITUTED GARNET

(71) Applicant: Hyundai Motor Company, Seoul (KR)

(72) Inventors: Ju Young SUNG, Suwon-si (KR); Sam Ick SON, Suwon-si (KR); Ho Taek LEE, Seoul (KR)

(73) Assignee: HYUNDAI MOTOR COMPANY, Seoul (KR)

(21) Appl. No.: 14/295,130

(22) Filed: Jun. 3, 2014

(30) Foreign Application Priority Data
Nov. 12, 2013 (KR) 10-2013-0136935

(51) Int. Cl. C04B 35/488; C04B 35/64

(52) U.S. Cl. CPC C04B 35/4885; C04B 35/64
USPC 264/406; 264/666

(57) ABSTRACT

A method for preparing a cubic phase Li₇La₃Zr₂O₁₂ (LLZ) includes dry-mixing Li₂CO₃, La₂O₃, ZrO₂ and Al₂O₃. The mixture is fired at 800° C. to 1,000° C. for 5 to 7 hours, naturally cooled, and dry-mixed. A pellet having a size from 8 mm to 12 mm at 120 MPa to 150 MPa is manufactured using the mixture. Then, the pellet is fired at 1,000° C. to 1,250° C. for 20 to 36 hours.

### CROSS-REFERENCE TO RELATED APPLICATIONS

This application claims the benefit of priority to Korean Patent Application No. 10-2013-0136935 filed in the Korean Intellectual Property Office on Nov. 12, 2013, the entire contents of which are incorporated herein by reference.

### TECHNICAL FIELD

The present disclosure relates to a method for preparing a cubic structure while a lithium site is substituted with aluminum (Al) when Al is added to Li₇La₃Zr₂O₁₂ (hereinafter, referred to as LLZ) having excellent ionic conductivity among garnet-based materials.

More particularly, the present disclosure relates to a method for enhancing physical properties of Li₇La₃Zr₂O₁₂ (LLZ) by adding aluminum (Al) to LLZ which is present in a cubic phase at normal temperature to stabilize a cubic structure while a lithium site is substituted with the Al and to exhibit a liquid sintering effect, thereby increasing density.

### BACKGROUND

Inorganic-based solid electrolytes are chemically divided into oxides and sulfides, and examples of a candidate for oxide-based solid electrolytes having excellent conductivity include perovskite and garnet. The present disclosure is limited to LLZ among garnet-based materials.

Studies on materials may be largely classified into three steps of synthesis, analysis and evaluation. Among them, the synthesis step is an important part which may determine physical properties of a material and greatly affects the independent development of the material in the future. FIG. 1 illustrates the synthesis process of LLZ.

European Patent Application Publication No. EP 2159867 A1 discloses a method for analyzing a relationship of Li conductivity according to the content of Al in Al₂O₃ included in Li₇La₃Zr₂O₁₂ among garnet-based materials.

The paper, Synthesis of Garnet Structured Li₇+x La_{3Y} x Zr₂₋ₓ O₁₂ (x=0−0.4) by Modified Sol-Gel Method, discloses a method for synthesizing an electrolyte according to the temperature and the amount of oxygen when a cubic phase of Li₇La₃Zr₂O₁₂ among garnet-based materials is prepared.

The paper, Synthesis of Cubic Li₇La₃Zr₂O₁₂ by Modified Sol-gel Process, discloses the analysis of the relationship of Li conductivity according to the content of Al in Al₂O₃ included in Li₇La₃Zr₂O₁₂ among garnet-based materials.

Korean Patent Application Publication No. KR 10-2010-0053543 A discloses a use of a solid ion conductor which has a garnet-type structure and is chemically stable in batteries, storage batteries, electrochromic devices and other electrochemical batteries, and a new compound suitable for use thereof.

### SUMMARY

The present disclosure provides a method for adding aluminum (Al) which stabilizes a cubic structure of Li₇La₃Zr₂O₁₂ while being substituted with lithium, and further provides an analysis result of changes in density and sintering of the cubic structure, which occur according to the amount of Al.

According to an exemplary embodiment of the present disclosure, a method for preparing a cubic phase Li₇La₃Zr₂O₁₂ (LLZ) includes dry-mixing Li₂CO₃, La₂O₃, ZrO₂ and Al₂O₃.The mixture is fired at 800° C. to 1,000° C. for 5 to 7 hours, naturally cooled, and dry-mixed.

A pellet having a size from 8 mm to 12 mm at 120 MPa to 150 MPa is manufactured using the mixture. Then, the pellet is fired at 1,000° C. to 1,250° C. for 20 to 36 hours.

According to the present disclosure, Li in the cubic phase LLZ is substituted with Al.

The substituted Al may be present in an amount of 0.52 mol to 0.80 mol, and the LLZ is doped with Al₂O₃ in an amount of 2.5 wt % to 3.76 wt %.

The present disclosure implements a method for adding Al, which stabilizes a cubic structure of Li₇La₃Zr₂O₁₂ while substituting for lithium and an analysis of density changes and sintering of the cubic structure, which occur according to the amount of Al.

### BRIEF DESCRIPTION OF DRAWINGS

FIG. 1 illustrates a synthesis process of Li₇La₃Zr₂O₁₂ (LLZ).

FIG. 2 is an XRD phase change graph according to a synthesis process of LLZ.

FIG. 3 illustrates a final firing method and a sample photograph after firing.

FIG. 4 is an XRD graph of LLZ according to a phase.

FIG. 5 illustrates an ICP-MS analysis process for analyzing the LLZ composition.

FIG. 6 illustrates measuring conductivity by forming an electrode on LLZ using an Au sputter and then inserting the LLZ into a jig for an impedance measurement.

FIG. 7 is a graph showing the results of measuring the impedance of LLZ.

FIG. 8 illustrates XRD measurement results of Al doped LLZ (amount of Al₂O₃ added 5 wt % to 20 wt %).

FIG. 9 illustrates the result of a Raman measurement of Al doped LLZ.

FIG. 10 illustrates the result an ICP-MS measurement of Al doped LLZ.

FIG. 11 illustrates the result of an XRD measurement of the addition of 0 wt % to 4 wt % of Al₂O₃.

FIG. 12 illustrates the use of a BN plate and the use of a MgO crucible during the firing of LLZ.

FIG. 13 illustrates the result of an LLZ impedance evaluation of up to 4 wt % of Al₂O₃.

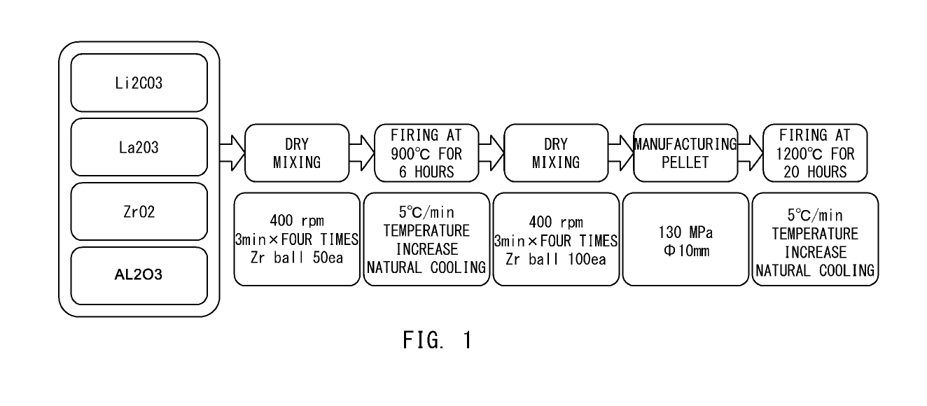

### DETAILED DESCRIPTION

The present disclosure provides a method for preparing a cubic phase Li₇La₃Zr₂O₁₂ (LLZ). The method includes dry-mixing Li₂CO₃, La₂O₃, ZrO₂ and Al₂O₃.

The mixture is fired at 800° C. to 1,000° C. for 5 to 7 hours, naturally cooled, and then dry-mixed. A pellet having a size from 8 mm to 12 mm at 120 MPa to 150 MPa is manufactured using the mixture, and then the pellet is fired at 1,000° C. to 1,250° C. for 20 to 36 hours. In the present disclosure, Li in a cubic phase of LLZ is substituted with Al. The substituted Al is present in an amount of 0.52 mol to 0.80 mol, and the LLZ is doped with Al₂O₃ in an amount of 2.5 wt % to 3.76 wt %. The dry-mixing ratio of Li₂CO₃:La₂O₃:ZrO₂:Al₂O₃ may be 7 mol:3 mol:4 mol:0.813 mol.

The method for preparing a cubic phase LLZ may further include a process of manufacturing a pellet using 10% to 80% of the dry mixture before the pellet firing step, and covering the pellet with powder of the remaining dry mixture.

The method for preparing a cubic phase LLZ according to the present disclosure further includes analyzing the prepared LLZ by using X-ray diffraction (XRD), Raman spectroscopy or inductively coupled plasma mass spectrometry (ICP-MS). The method further includes determining the phase of LLZ and impurities by XRD.

The method of the present disclosure further includes determining the phase and impurities of a region having a size of several hundreds of microns or less, which may not be determined by XRD or Raman. The composition ratio of each element in the LLZ is compared with a target composition ratio by ICP-MS.

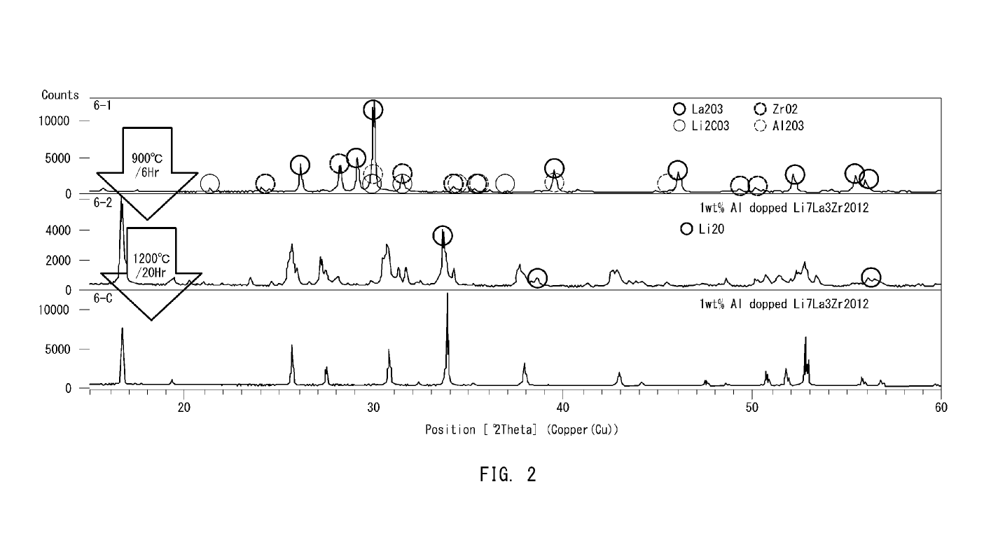

The LLZ has cubic and tetragonal phases. The cubic phase has a conductivity level of 10⁻⁴/Ωcm, and the tetragonal phase has a conductivity level of 10⁻⁶/Ωcm. It has been reported that the cubic phase is better than the tetragonal phase by 100 times or more in terms of conductivity. Accordingly, it is advantageous to synthesize only the cubic phase in terms of enhancing physical properties, such that, impurities and the secondary phase or tetragonal phase are not generated. Among the raw materials for the LLZ, La₂O₃ has hygroscopicity, and thus was used after a drying process at 900° C. for 24 hours. Furthermore, a small amount of Al₂O₃ is used in order to enhance physical properties. Examples of the mixing method include a dry-type method and a wet-type method. Here, the dry-type mixing was performed using a planetary mill (hereinafter, referred to as P.M.) because there is a concern of an increase in process time (an increase of one day or more until dried) and a side reaction with a solvent with the wet-type mixing. As a dry-type mixing condition, a condition was selected under which an optimal powder size (a level of several microns) could be secured in the smallest time by analyzing, by SEM imaging, a powder for each step and a sample for each P.M. time. During the synthesis of LLZ, the LLZ is generally subjected to a firing process two times. Referring to FIG. 2, through a primary firing, the LLZ is formed and a part of the unstable phase (La₂Zr₂O₇, Pyrochlore) and a part of raw materials exist together, and through a secondary firing, all the impurities take part in the reaction or disappear, and as a result, only an LLZ having a desired cubic structure exists. In particular, during the secondary firing, a change in firing temperature and time greatly affects determination of the phase. Since a temperature of 1250° C. or more favors production of an unstable phase and a temperature less than 1150° C. favors formation of a tetragonal phase, the temperature and time of the present synthesis process are accordingly determined.

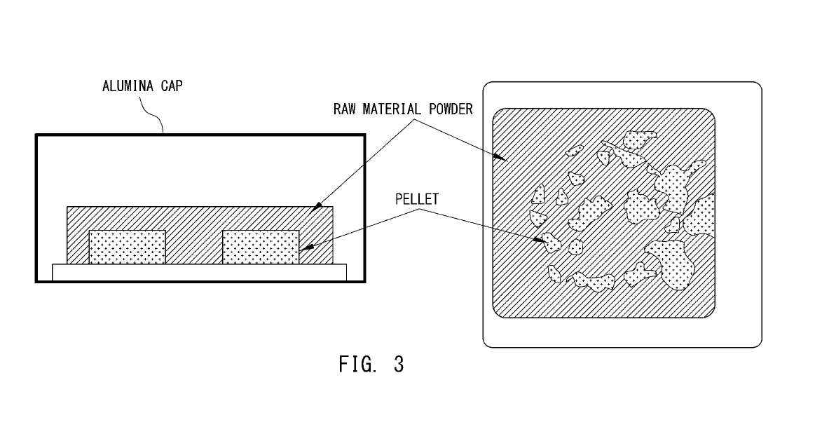

The lithium composition which affects conductivity may also vary according to the firing process. In particular, in the secondary firing process, the LLZ is exposed to high temperature (1200° C.) for a long time (20 hours), and volatilization of lithium in the LLZ occurs. Referring to FIG. 3, a method for producing a desired lithium composition while preventing the volatilization additionally includes a process of manufacturing a pellet using 10% to 80% of the dry mixture before Li₂CO₃ is used in excess (10% excess) and a final firing (about 1200° C. for 20 hours) is performed in consideration of volatilization at the initial stage. The pellet is covered with the remaining powder of the dry mixture.

Through an analysis, it is determined whether LLZ having a desired hexahedron phase (cubic phase) is synthesized. The three analyzing methods, such as XRD, Raman, and ICP-MS, may be performed. The LLZ phase and impurities may be confirmed by XRD, and Raman spectroscopy confirms the phase and impurities of a region having a size of several hundreds of microns or less, which may not be determined by XRD. Further, a difference between a target composition and a synthesis composition is compared by confirming the composition ratio of each element of the LLZ by ICP-MS.

Due to the absence of XRD data of the LLZ during the initial synthesis, the comparison and determination was made by collecting the XRD data of LLZ, which are reported in the documents.

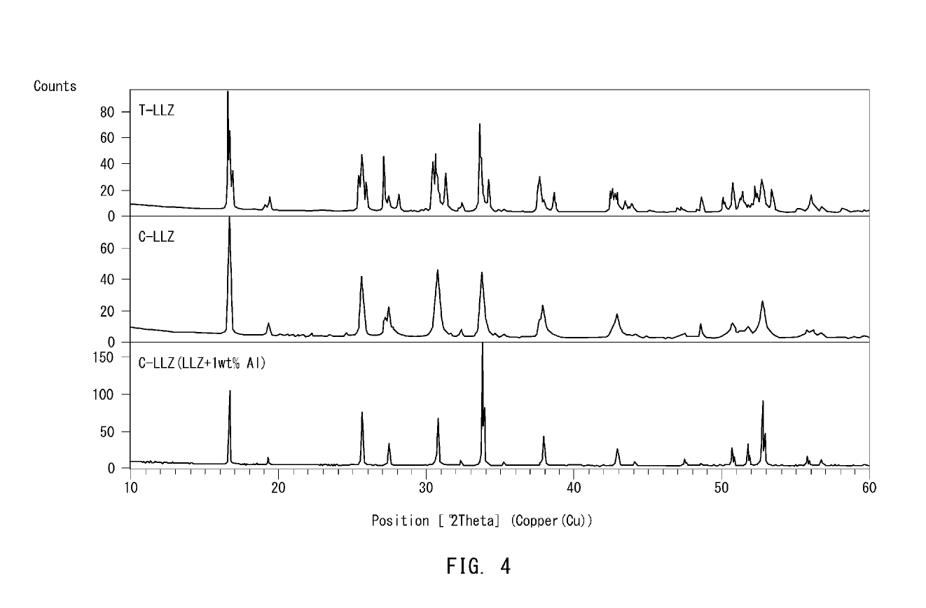

A sintered pellet is ground into a powder using a mortar, and measurements are made. Measurements may be performed using Bruker D8 ADVANCE as a measurement apparatus at a measurement rate of 3 degrees/minute in a range from 10 degrees (°) to 60 degrees (°). Referring to FIG. 4, the peak of tetragonal LLZ (hereinafter, referred to as T-LLZ) is widely distributed as compared to the peak of cubic LLZ (hereinafter, referred to as C-LLZ) and observed to be split. This phenomenon is observed due to low crystallinity of the T-LLZ. Furthermore, when a small amount of Al is added, even though the phase is a cubic phase, a sharper peak is observed. That is, the crystallinity may be further improved. In general, when a cubic crystallinity in LLZ is improved, the lithium transfer is facilitated, and ionic conductivity is measured at a high level.

During the synthesis, it is difficult to synthesize a desired composition due to an error in weighing raw materials, volatilization of lithium caused by sintering at high temperature, an Al doping phenomenon in the pellet caused by an alumina crucible, and the like. For a precise composition analysis of the synthesized LLZ, an ICP-MS evaluation method may be utilized. Unlike other materials, the LLZ is a ceramic material, and it is difficult to completely dissolve the powder using a general pre-treatment process for the ICP analysis.

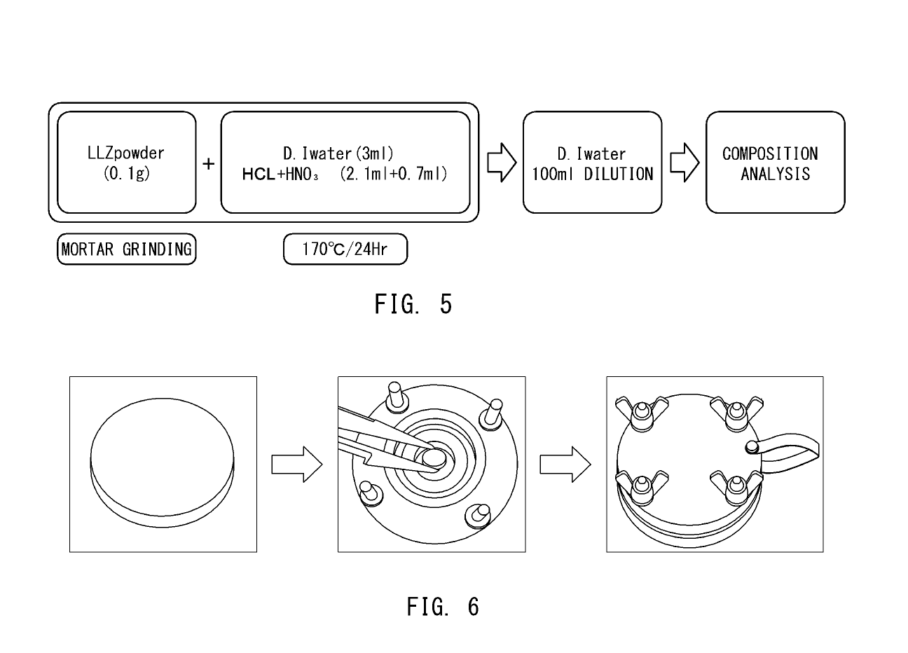

FIG. 5 illustrates a process of subjecting the LLZ composition to an ICP analysis. For complete dissolution, aqua regia (hydrochloric acid:nitric acid=3:1 vol %) is prepared and boiled at 170° C. to completely dissolve the powder, and then diluted to determine the composition. As a result of reproducibility evaluation with the same sample, La, Zr and Al secured reproducibility with an error within 3%, while Li exhibited an error with a level of 12%.

For the development of a solid electrolyte, it is necessary to evaluate physical properties of a solid phase different from a liquid phase. Installation of an apparatus, establishment of an evaluation method, and interpretation of an evaluation result are essential prerequisite conditions for development of the solid electrolyte. An optimization of evaluation conditions was performed based on the experimental results according to an area of the LLZ, a material for forming an electrode, the thickness and area, an electrode pairing, the design of the measurement jig, and conditions of an impedance analysis apparatus. In the procedure, an intensive study was conducted for overcoming problems essentially occurring in the synthesis of the material itself, which is different from commercially available materials. The LLZ is manufactured in the form of a pellet, and an impedance evaluation result is reliable at levels having a thickness of 1 mm to 2 mm, an Au sputtering of 100 nm, and an electrode area of 63 mm².

As in FIG. 6, conductivity was measured by forming an electrode on LLZ using an Au sputter and then inserting the LLZ into a jig for an impedance measurement. In the measurement of conductivity, the region of frequency number and the intensity of voltage, which are measured according to the material, vary. The LLZ was measured under conditions of a frequency number from 20 MHz to 1 Hz and a voltage of 30 my using a Solartron 1260 apparatus.

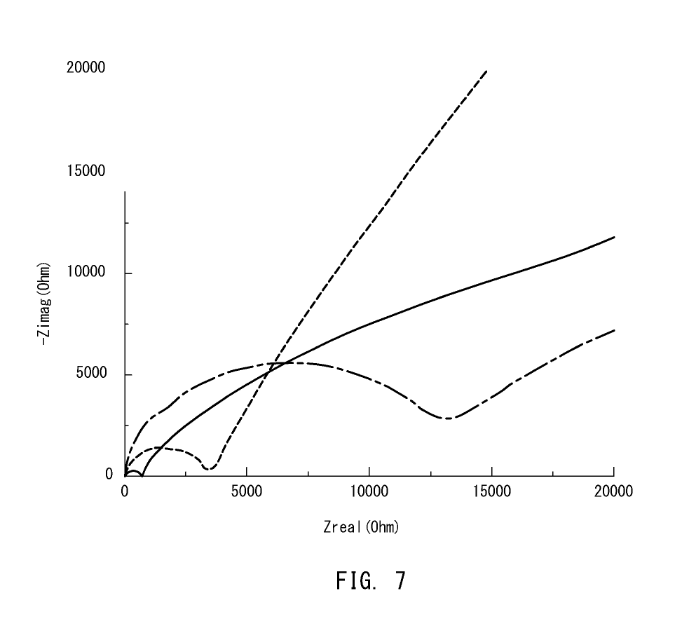

Referring to FIG. 7, the resistance value is found by inputting the impedance result into an equivalent circuit (-RC- single circuit, using a Z-VIEW software), and then a value of conductivity is derived therefrom. In addition, it is also possible to evaluate an asymmetric cell (Au/LLZ/Li) DC for measuring ionic conductivity and electronic conductivity separately, or a symmetric cell (Li/LLZ/Li) DC for confirming compatibility of lithium with the LLZ.

In order to enhance physical properties of the LLZ, it is advantageous to increase the sintering density and allow the LLZ to be present as a cubic phase at normal temperature. As a method for simultaneously satisfying the two conditions, Al is added to the LLZ. The addition of Al may stabilize the cubic structure while the lithium site is substituted with Al and may exhibit an effect of sintering a liquid phase, thereby expecting an increase in density. In this case, 10% of excess Li₂CO₃ may be used in consideration of volatilization of lithium. The results of Examples in which an alumina crucible is used, and the ratio of Al₂O₃ added with 0, 0.5, 1, 2, 3, 4, 5, 10, 15, and 20 wt % are as follows in Table 1. The synthesis process was performed as it was, the analysis was performed with XRD, Raman and ICP, and an impedance analysis was performed.

TABLE 1
Evaluation Result of Al doped LLZ

| | Synthesis | | Analysis | | | |
|---|---|---|---|---|---|---|
| | Amount | Sin- | | | ICP-MS | Evaluation |
| | of Al₂O₃ | tering | | | (Amount | Conduc- |
| | (wt %) | density | | | of Al₂O₃ | tivity |
| No. | doping | (%) | XRD | Raman | wt %) | (/Ωcm) |
| 9-1 | 0 | 83 | Cubic | Cubic | 2.50 | 8.48*10⁻⁵ |
| | | | Phase | Phase | | |
| 9-2 | 0.5 | 80 | Cubic | Cubic | 2.96 | 1.49*10⁻⁴ |
| | | | Phase | Phase | | |
| 9-3 | 1 | 84 | Cubic | Cubic | 3.14 | 8.92*10⁻⁵ |
| | | | Phase | Phase | | |
| 9-4 | 2 | 83 | Cubic | Cubic | 3.63 | 1.30*10⁻⁴ |
| | | | Phase | Phase | | |
| 9-5 | 3 | 79 | Cubic | Cubic | 3.76 | 1.60*10⁻⁴ |
| | | | Phase | Phase | | |
| 9-6 | 4 | 78 | Cubic | Cubic | 3.68 | 2.35*10⁻⁴ |
| | | | Phase | Phase | | |
| 9-7 | 5 | 77 | Cubic | Impurity | 4.58 | 5.12*10⁻⁵ |
| | | | Phase | peak | | |
| | | | Al₃Zr | | | |
| 9-8 | 10 | 73 | LaAlO₃ | Impurity | 10.00 | 5.00*10⁻⁷ |
| | | | Li₂ZrO₃ | peak | | |
| 9-9 | 15 | 72 | LaAlO₃ | Impurity | 16.25 | 4.63*10⁻⁷ |
| | | | Li₂ZrO₃ | peak | | |
| 9-10 | 20 | 79 | LaAlO₃ | Impurity | 21.63 | 4.26*10⁻⁷ |
| | | | Li₂ZrO₃ | peak | | |

Referring to Table 1, as the amount of added Al₂O₃ is increased during the synthesis, the relative density tends to decrease. In particular, when an amount of 3 wt % or more is added, a density of 80% or less is observed, thereby providing a condition adversely affecting conductivity.

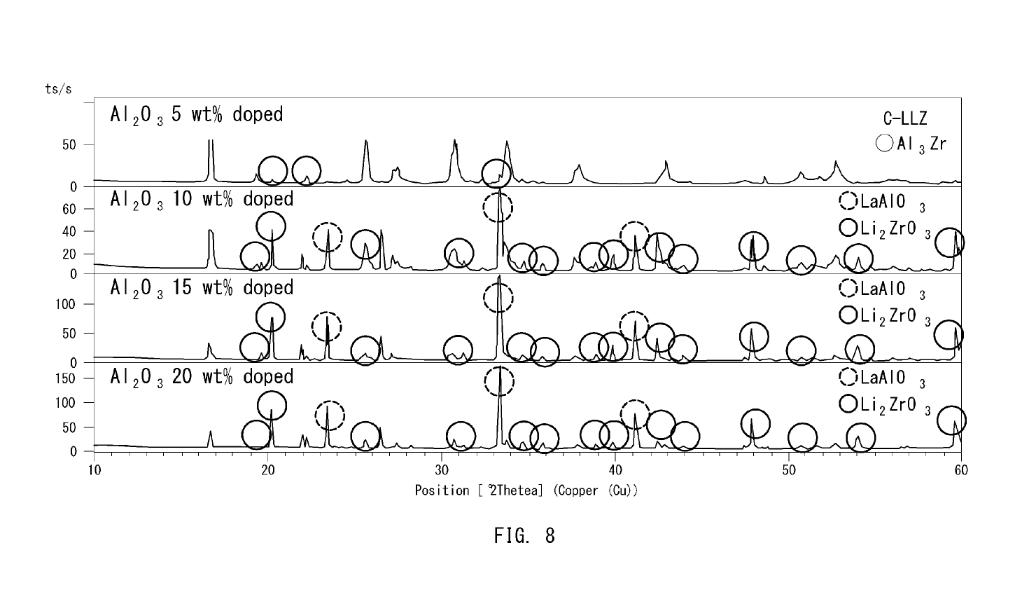

As a result of the XRD analysis in FIG. 8, impurities begin to be produced when Al₂O₃ is added in an amount of 5 wt % or more, and LLZ may not be observed during an addition in an amount of 10 wt % or more. Although research institutes have reported that Al in LLZ is substituted with Li or Zr, studies on whether the substitution may be made up to what limitation amount have not been yet conducted. Based on the result of the present disclosure, it is determined that the substitution may be made in a level of 4 wt % of Al₂O₃, and it is possible to determine the amount of Al₂O₃ added, which shows the best physical properties from the judgment.

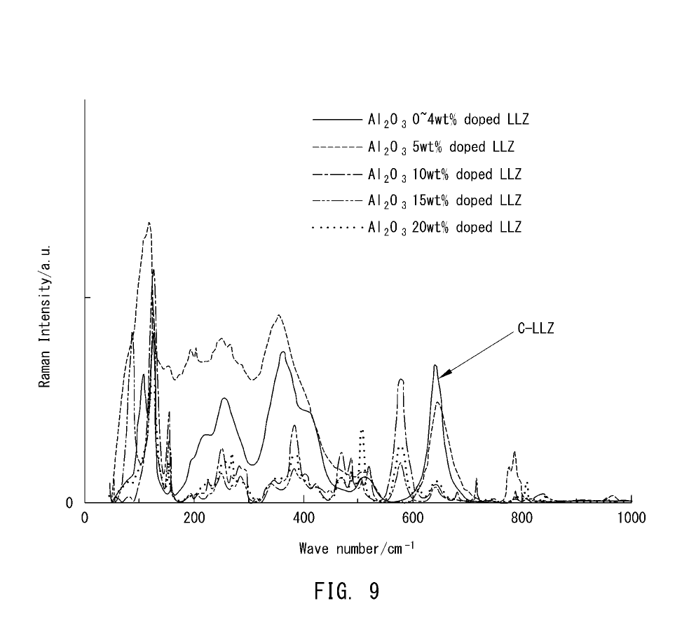

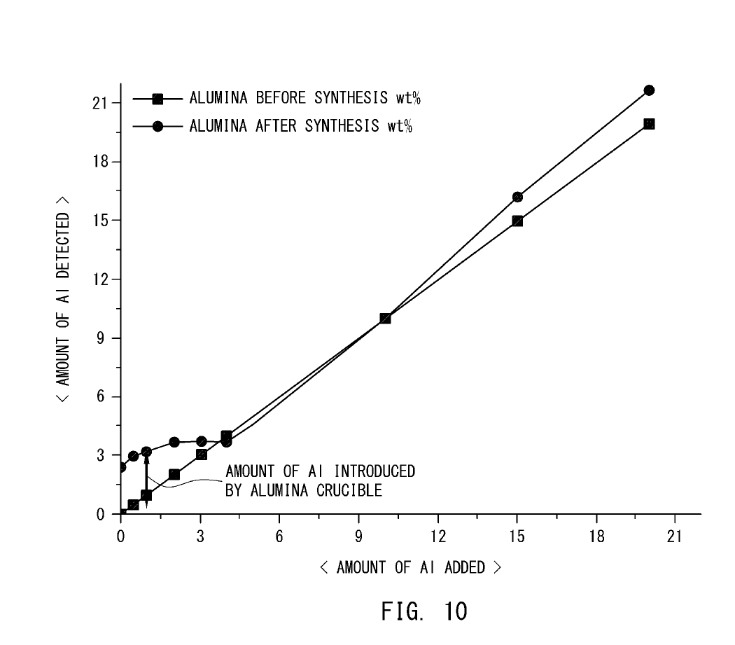

The Raman spectroscopy measurement result in FIG. 9 is also observed equally to the analysis result of the XRD phase. When Al₂O₃ added in an amount of from 0 to 4 wt %, the C-LLZ is observed in all the results, but during the addition of 5 wt % or more of Al₂O₃, different peaks and intensity are observed.

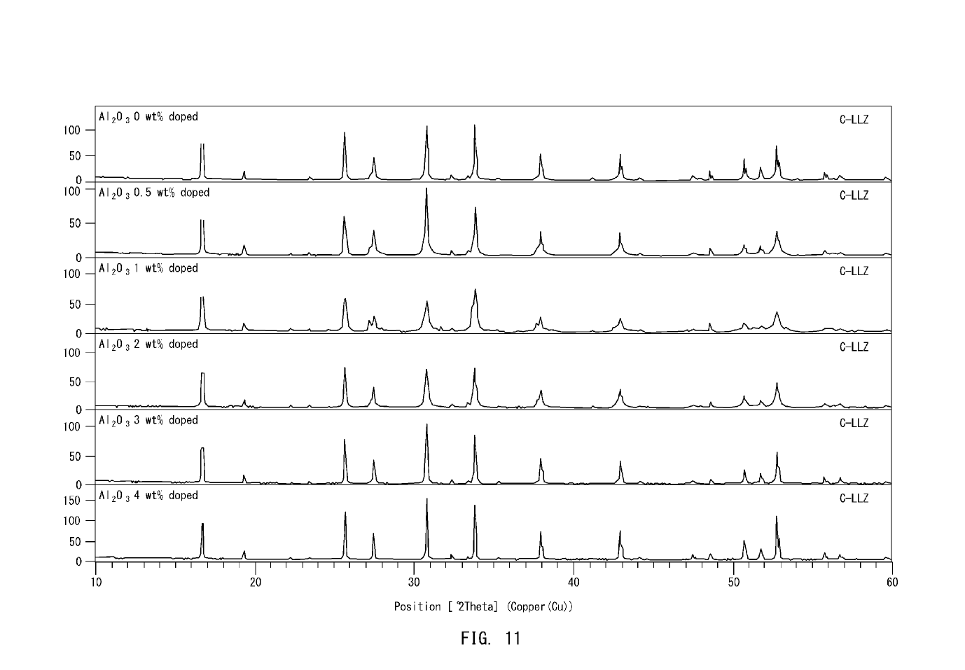

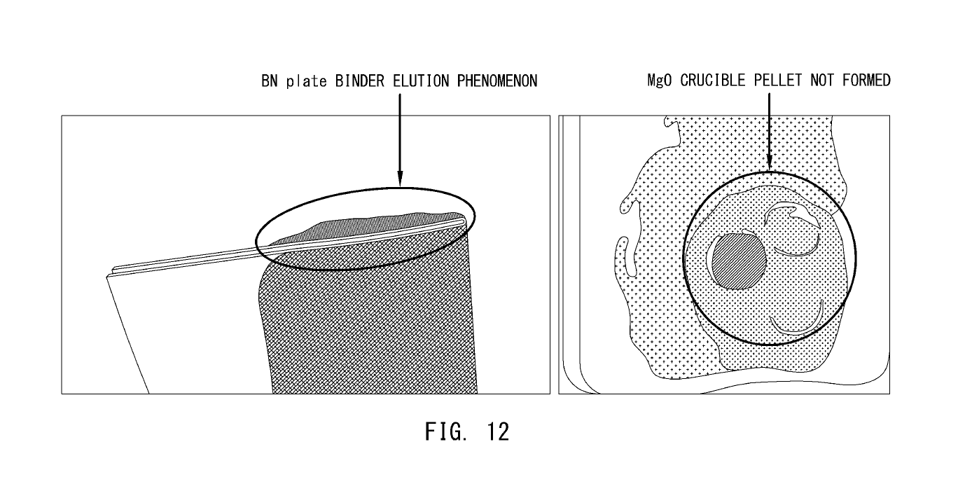

As determined ICP-MS in FIG. 10, 2.5 wt % Al doped is observed due to the alumina crucible even when Al₂O₃ is not added. During the addition of a small amount of Al₂O₃ (0 to 3 wt %), the amount of Al detected due to the crucible is greatly increased, but during the substitution of 4 wt % or more of Al₂O₃, a level similar to the amount of Al₂O₃ added is detected. Thus, it is difficult to control the amount of alumina added. The present disclosure further provides a method for preventing the introduction of Al by blocking direct contact of an alumina crucible with a sample. Specifically, the use of a boron nitride (BN) plate or an MgO crucible during the firing prevents the introduction of Al.

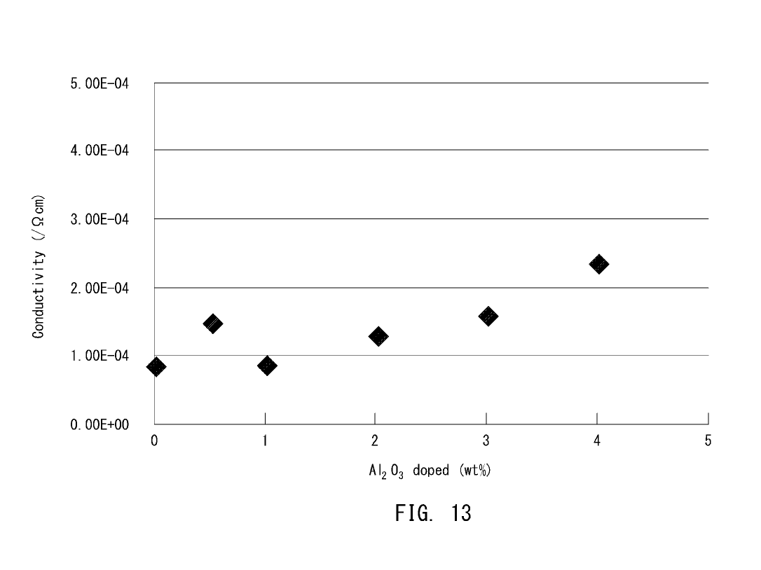

FIG. 12 illustrates an evaluation result of using a BN plate over an alumina crucible and an evaluation result of using an MgO crucible instead of the alumina crucible. It is not possible to secure a sample because a phenomenon in which the sample is molten with a binder component due to elution of the binder component of the BN plate is caused by the use of the BN plate during the firing at 1,200° C. Even though the final firing is performed when the MgO crucible is used, a pellet may not formed, and a sintering phenomenon between powders may not occur at all.

Meanwhile, as a result of the impedance evaluation, a similar conductivity (a level of σ=10⁻⁴/Ωcm) is observed up to 4 wt % of Al₂O₃ (see FIG. 13), but during the addition of 5 wt % or more, conductivity is sharply decreased while impurities are produced (a level of σ=10⁻⁷/Ωcm).

Therefore, physical properties may be enhanced while maintaining the cubic phase of the LLZ due to substitution of Al in the LLZ, but physical properties deteriorate due to production of impurities during the addition of 4.6 wt % or more of Al₂O₃.

What is claimed is:

1. A method for preparing a cubic phase Li₇La₃Zr₂O₁₂ (LLZ), the method comprising:
dry-mixing Li₂CO₃, La₂O₃, ZrO₂ and Al₂O₃ to form a mixture;
firing the mixture at 800° C. to 1,000° C. for 5 to 7 hours;
naturally cooling the mixture and then secondly dry-mixing the mixture;
manufacturing a pellet comprising the mixture having a size from 8 mm to 12 mm at 120 MPa to 150 MPa; and
firing the pellet at 1,000° C. to 1,250° C. for 20 to 36 hours.

2. The method of claim 1, wherein Li in the cubic phase LLZ is substituted with Al.

3. The method of claim 2, wherein the substituted Al is present in an amount of 0.52 mol to 0.80 mol, and the LLZ is doped with Al₂O₃ in an amount of 2.5 wt % to 3.76 wt %.

4. The method of claim 1, wherein a dry-mixing ratio of Li₂CO₃:La₂O₃:ZrO₂:Al₂O₃ is 7 mol:3 mol:4 mol:0.7 to 0.9 mol.

5. The method of claim 1, further comprising:
manufacturing a pellet using 10% to 80% of the dry mixture before the pellet firing, and covering the pellet with a powder of the remaining dry mixture.

6. The method of claim 1, further comprising:
analyzing the prepared LLZ,
wherein the analyzing is performed by X-ray diffraction (XRD), Raman spectroscopy, or inductively coupled plasma mass spectrometry (ICP-MS).

7. The method of claim 6, wherein the analyzing determines a phase of the LLZ and impurities by XRD.

8. The method of claim 6, wherein the analyzing determines the phase and impurities of a region having a size of several hundreds of microns or less, which may not be determined by XRD or Raman.

9. The method of claim 6, wherein the analyzing compares a composition ratio of each element in the LLZ with a target composition ratio by ICP-MS.
